(19) United States
(12) Patent Application Publication
(10) Pub. No.: US 2008/0243608 A1
(43) Pub. Date: Oct. 2, 2008

(54) CREATION OF CUSTOMIZED INSTANCES OF PUBLICATIONS

(76) Inventors: Ehud Chatow, Palo Alto, CA (US); Andrew E. Fitzhugh, Menlo Park, CA (US); Nathan M. Moroney, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/694,914

(22) Filed: Mar. 30, 2007

(51) Int. Cl. G06Q 30/00

(52) U.S. Cl. 705/14

(57) ABSTRACT

Customized instances of a publication created. The instances are customized according to interests of different recipients.

This application is related to U.S. Ser. No. 11/460,488 filed Jul. 27, 2006. U.S. Ser. No. 11/460,488 is incorporated herein by reference.

### BACKGROUND

Desktop publishing combines a personal computer and page layout software to create publication documents. Desktop publishers can create page layouts with text, graphics, photos and other visual elements using commercial software packages. For small scale publishing, a few copies of a publication might be printed on a local printer. For large scale publishing, a computer file can be sent to a print service provider for high-volume printing.

### BRIEF DESCRIPTION OF THE DRAWINGS

FIG. 1 is an illustration of a publishing method in accordance with the present invention.

FIG. 2 is an illustration of a publishing system in accordance with an embodiment of the present invention.

FIG. 3 is an illustration of a publishing method in accordance with an embodiment of the present invention.

FIG. 4 is an illustration of a method of providing a publishing service in accordance with an embodiment of the present invention.

FIG. 5 is an illustration of a client machine and a server system in accordance with an embodiment of the present invention.

FIG. 6 is an illustration of distributed printing in accordance with an embodiment of the present invention.

### DETAILED DESCRIPTION

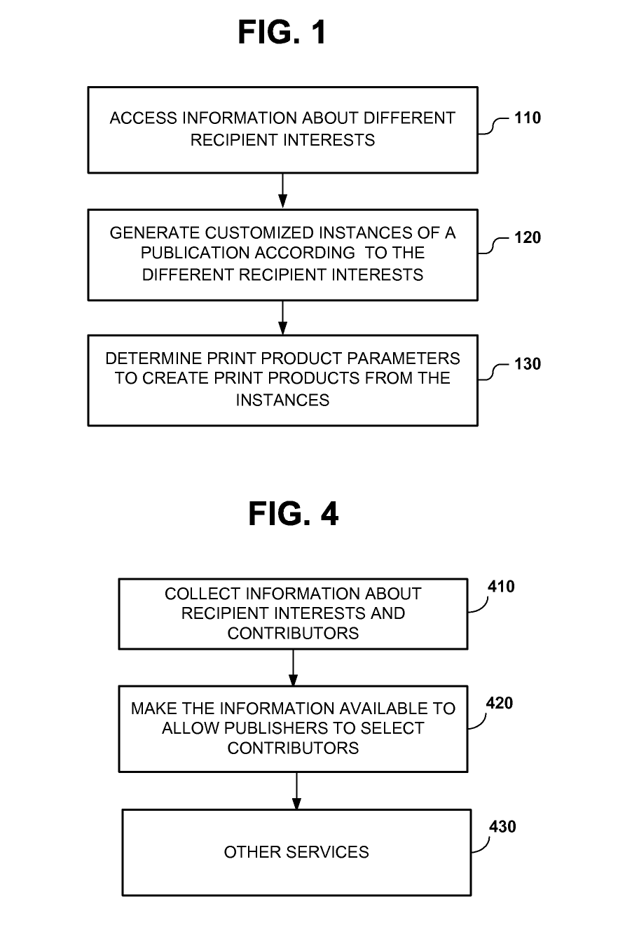

Reference is made to FIG. 1, which illustrates a general method of creating a publication. Information about interests of different recipients are accessed (block 110), and customized instances of the publication are generated for the different recipients (block 120). Each instance is customized according to its recipient's interests.

Each recipient may be an individual person. However, a recipient is not so limited. As used herein, a recipient may be a group of people, such as people having a common interest or a set of common interests. For example, a recipient could be a group of people in the same profession (e.g., editors, engineers), people in a social club, students and alumni, subscribers to a newsletter or other publication, employees, a customer base, a religious group, a travel group, members of a family, etc.

The recipient information might include geographic location, reading interests, hobbies, affiliations, memberships, desired level of advertising, etc. The recipient information may be ascertained from historical behavior. For example, recipient information could be ascertained from credit card and other shopping purchases, search history (e.g., queries that recipients submit to search engines), movie ratings (e.g., Netflix), travel history, educational history, books read, etc. The recipient information may also be ascertained from anticipated or future actions. For example, recipient information could be ascertained from travel plans, product inquiries, technical reviews that have been accessed, etc.

The recipient information could be provided directly by the recipients. For example recipients could provide information by participating in voluntary surveys, configuring preferences files, providing minimal user profiles, etc.

Each instance of the publication may contain common features. For example, each instance of the publication may contain common content, a common design (e.g., a common format, a certain look and feel, etc.), and common advertisements.

However, each instance also contains features that are customized according to its recipient's interests. As a first example, an instance contains customized content. Examples of customized content include stories of interest, regional information, certain editorials, photos from specific places of interest to a recipient, etc.

As a second example, an instance contains a customized design. Examples of a customized design include an appropriate template or style sheet, a theme for special occasion such as a birthday or wedding anniversary, a layout with cartographic styles for a recipient interested in travel, collegiate graphics (school logos, etc.) for sports magazines, use of a predominant color for a holiday (e.g., green for Saint Patrick's day), certain image borders or frames, fonts, page numbers and other graphical elements.

As a third example, an instance contains customized advertisements. Advertisements in an instance may be targeted to the specific interests of a recipient. For example, if a recipient expresses an interest in amateur photography, the customized instance might include advertisements by camera makers, memory card manufacturers, etc.

In addition, the level of advertising in an instance may be customized to its recipient's interests. For example, a recipient might be willing to pay full cost for an instance, provided that the instance does not contain advertising. Or a recipient might accept a certain amount of advertising in an instance so that the instance is subsidized in part by advertisements. As a result, the recipient's cost of the instance would be reduced.

The creation of customized instances is scalable. At one end of the scale is the creation of widely circulated professional publications that are customized for many different recipients having diverse interests. At the other end of the scale is the creation of publications that are customized for a select few recipients having similar, but slightly different interests.

At block 130, print product parameters may be determined for the customized instances. These parameters might specify print media type, color properties (e.g., CMYK, CMYKcm, hexachrome or larger gamut), soft or hard cover, binding options, varnish, gloss finishing, use of metallic colorants, use of non-standard or specialty fonts, dust jackets, etc. These print product parameters may be ascertained from or specified by the recipient interests.

The print product parameters are used to create print products from the customized instances. Examples of print products include, without limitation, photo albums, newspapers, journals, catalogs, pamphlets, travel guides, post cards, signage, product packaging and books, booklets, and magazines (e.g., family magazines, club magazines).

For certain publications, a single printer could print out all of the customized instances.

For other publications, however, creating a print product can involve more than simply printing. A print product might require specialty services, such as applying bindings, special finishes, etc. For certain publications, a single specialty provider might be able to provide all necessary services.

For certain other publications, however, there might be high setup costs associated with sending all of the customized instances to a single print service provider. For example, some instances might be printed in black and white, whereas other instances might be printed in color. Different customized instance might differ in their media type, color properties, binding options, gloss finishing, use of metallic colorants, use of non-standard or specialty fonts, dust jackets, etc.

To overcome this problem, an option is given to distribute the work load to more than one print service provider. Print service providers are selected by matching print service provider capability with recipient information. Print service providers can be differentiated by specialty capabilities and location, For example, a print service provider is selected according to efficient resource allocation and geography. Print services providers can be differentiated in other ways, such as one-on-one interaction.

Other factors may be considered in selecting print service providers. For instance, a print service provider might offer an incentive system that encourages customers to use its services. One incentive system is a points system, where a customer gets points for using a print service provider. The points may accrue according to number of prints, dollar purchases, free printing pages, etc. Incentives could include monetary incentives, print credits, product upgrades, fulfillment upgrades and such.

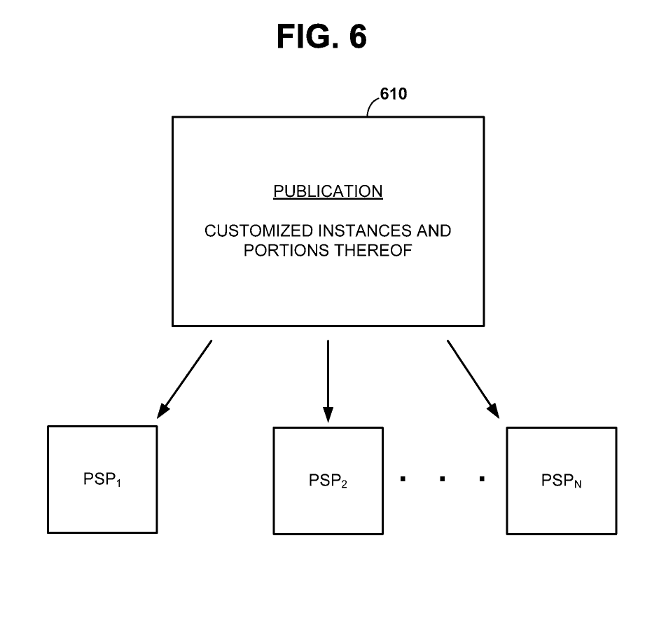

Reference is made to FIG. 6, which illustrates distributed printing among different print service providers PSP₁-PSP_{N}. The different print service providers PSP₁-PSP_{N} could be distinguished by different capability and geography. Print service providers PSP₁-PSP_{N} could be selected according to efficient resource allocation and geography. Print service providers PSP₁-PSP_{N} could also be selected according to an accrued points system.

A customized instance can be sent in its entirety to a print service provider. Or, different portions of an instance can be sent to different service providers, who then print the portions and send the printed portions to a central location for assembly into print products.

Reference is once again made to FIG. 1. The creation of customized instances will typically involve different functions. Creating a publication might involve functions such as content creation, publication design, and advertisements. Yet another function might involve selecting and managing the different parties who create and deliver the publications. Examples of some of these functions are provided below.

Still another function is that of a “subscriber.” Subscribers identify (e.g., sign up) recipients who will receive the customized instances. Subscribers may also provide information about recipients to the publication creator.

A single party could perform one or more of these functions, or different parties could perform different functions, or different parties could perform the same function. A party could be an individual, a group of people, an association, a corporation, a government, etc. Moreover, different parties could collaborate on the method of FIG. 1 to create customized instances of a publication. A party could also be a recipient.

In the examples that follow, parties that can contribute to the creation of publications will be referred to as “contributors.” These contributors may include without limitation content creators, editors, designers, advertisers, and print service providers. Also in the examples that follow, a party who selects and manages the contributors will be referred to as a “publisher.”

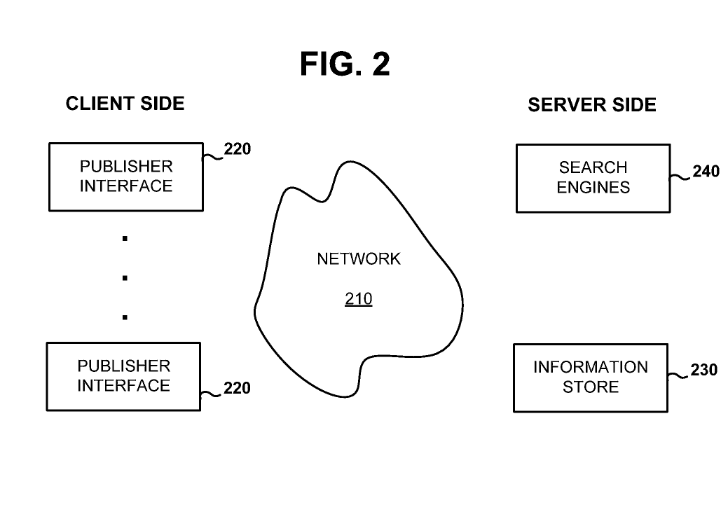

Reference is made to FIG. 2, which illustrates an exemplary system for creating customized instances of a publication. The system includes a client side and a server side. The client side and the server side communicate over a network 210. The network 210 is not limited to any particular type. The network 210 could be a computer network such as a LAN, the Internet, a cellular network, a peer-to-peer network, a personal area network (e.g., a network that uses Bluetooth), etc.

The client side includes a plurality of publisher interfaces 220. As an example, a publisher interface 220 may be browser-based. The browser-based interface can download information from the server side, and upload information to the server side.

A publisher interface 220 is not limited to a browser. In some embodiments, a publisher interface 220 may be a standalone program such as a desktop publisher. Other examples are described below.

The server side includes an information store 230 for storing information about the contributors. The information store 230 may also store recipient information, as well as information about the publishers. In some embodiments, the contributors and publishers might be required to sign up as members to a service. The information store 230 could also include the membership information.

The server side also includes search capability in the form of one or more search engines 240. A conventional search engine 240 may be used to match information submitted by the publisher with information stored in the information store 230.

Contributors can utilize the publisher interfaces 220 to store their information in the information store 230. A publisher can utilize a publisher interface 220 to search for contributors and manage the creation and delivery of the customized instances. However, in some embodiments, a publisher interface might be able to access the information store 230 directly, without the need for a search engine 240. For instance, simple manual searches from listings and sorted data bases may be performed.

The source of information that is searched is not limited to the information store 230. Other searchable content (e.g., public databases, web-addressable content) may be searched as well.

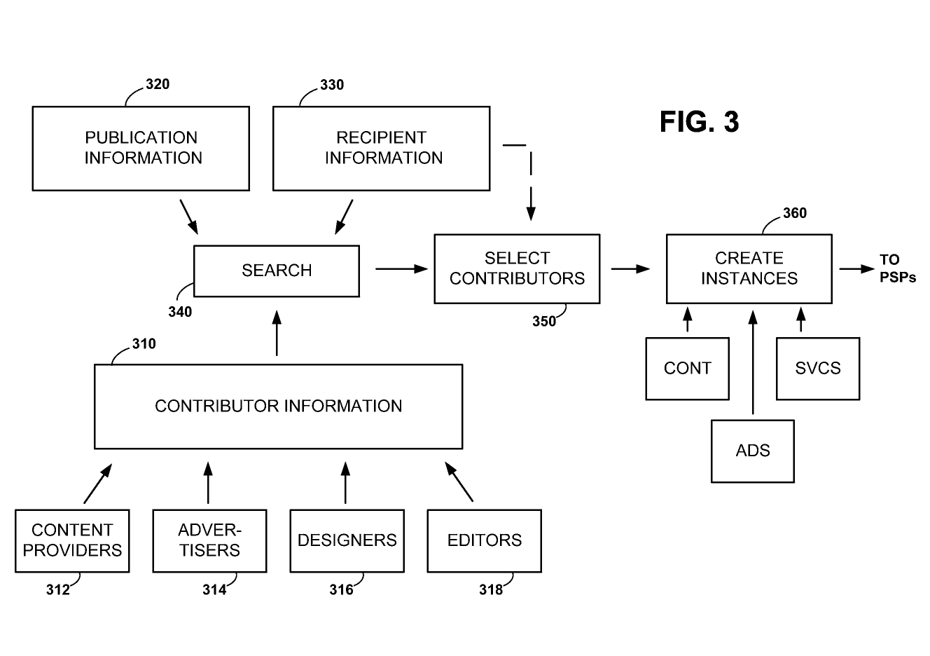

Reference is now made to FIG. 3. Information 310 about different contributors is stored in the information store. In the example of FIG. 3, the contributors include content providers 312, advertisers 314, designers 316, and editors 318.

Content providers 312 could submit their content or provide links to their content. The content providers 312 could also specify rights, cost per content, type of people who would be interested, etc. Content providers 312 could also specify the types of publications where their content can be published or used.

Advertisers 314 could specify their products and services, different forms of advertisement, cost per advertisement, intended targets, etc.

Designers 316 could supply sample templates and style sheets. Designers could provide sets of instructions for creating themes. Designers could review image and graphical content and could make recommendations or edit these images or graphical content. Designers could act as consultants for the overall appearance or could directly perform specific creative tasks. For instance, a premium publication might contract with a font designer to create a custom font to be used by a layout designer, or to create document or section templates.

To create customized instances of a publication, a publisher accesses a publisher interface, and the publisher interface queries the publisher for information 320 about the publication. For example, the publisher interface might display a set of forms (e.g., html forms, pdf fillable files) that the publisher fills in. The publication information 320 might include circulation, content type, delivery type, advertisement subsidization and other cost estimates, and other information that will allow contributors to determine whether they can (and want to) contribute to the publication. At this stage, information 330 about the recipient interests could also be submitted.

The submitted information is processed by a publication service provider. The publication service provider accesses a database and uses a search engine 340 to identify a list of contributors who might be (but are not necessarily) interested in creating the publication. The list might include sample work, credentials, prices, profiles, and other information that allows the publisher to select the contributors. The publication service provider could also provide feedback about the various contributors, for example as a star rating. The search engine 340 can actively rank the contributors. The match does not have to be exact. Rather it reflects a convergence of interests.

Instead of submitting a list of contributors directly to publisher, the publication service provider might identify different contributors and ask them to submit bids to the publisher. Those parties who are interested will submit the bids to the publisher. Interested parties could submit their bids via the publisher interface or by some external means (e.g., e-mail).

Armed with this information, the publisher then selects the contributors 350 who will create the customized instances of the publication. The publisher can then utilize the publisher interface to notify the contributors who were selected.

If not done already, the publisher can submit recipient information 330 to the selected contributors 350. The publisher can also submit additional information to the selected contributors 350.

The selection stage can also involve agreeing upon specific content and advertisements, agreeing on a level of advertising that a recipient is willing to allow, etc. This stage can also involve obtaining Intellectual Property rights in selected content and agreeing to royalty payments.

The interface can be used to manage transactions such as the flow of money between the parties. For example, a content provider could use the interface to collect royalties, a subscriber could use the interface to pay a subscription fee, etc.

The contributors can then create the customized instances 360. There is no particular manner in which the instances are created. Consider the following example of creating a publication. A template is accessed, and different contributors make their contributions to the template (e.g., adds content, advertisements). By making a contribution to the template, a contributor limits the amount of information that can be added by the next contributor.

Certain contributors may work under their own supervision, or they might be supervised by one or more editors 318.

Customized instances may be created over multiple iterations, where each iteration includes sending a template from contributor to contributor. During each iteration, a party could modify or remove its previous contribution, or make an additional contribution. During initial iterations, common features (a common design, common advertisements, common content) could be added to the template. During additional iterations, customized instances could be created from the template, where customized features are added to each instance.

In another example, instances are created sequentially, in which each contributor supplies its contribution, and then passes its work to the next contributor. For example, a designer adds standard and custom designs to publication instances, and passes the semi-completed instances to a content provider. The content provider adds its standard and custom content and then passes the semi-completed instances to the next content provider. After content has been added, the semi-completed instances are passed around to different advertisers, who add standard and custom advertisements. This too can be an iterative process.

In another example, designers, content providers and advertisers could submit their information to editors, who arrange the information into customized instances. The editors could arrange the information manually or through an automated process.

In yet another example, different contributors can own different predefined parts of the publication so the customized instances can be processed in parallel. Many of the different contributors can either focus on providing templates or highly refined instances of their contributions. A designer might provide a template for a book cover page, an advertiser might provide a full bleed color advertisement targeted to a specific demographic, etc. Likewise many of the different contributors can work on individual components without access to the entire custom content, such as a professional editor proof reading the text of an article or a photographer manually editing a cover image.

Subscribers could also supply content to the contributors. Subscriber-supplied content is not limited to any particular source.

Quality control of the customized instances could be performed in a variety of ways and at different levels. For instance, contributions can be progressively validated and ranked by publishers. Designers with less appealing cover templates for a book will likely be used less frequently than designers with more appealing cover templates. Publishers could rank their satisfaction with various contributors to the customized content so that shared history and ranking could be used to build trust in the system.

Publishers might preview the publications as they are being created. This might be done electronically, using a form or display technology to assess how specific content templates would work for their content.

Once the customized instances have been created, they can be sent in electronic form to one or more print service providers.

Reference is now made to FIG. 4, which illustrates a method of providing a publishing service to subscribers and contributors. At block 410, information is collected about recipient interests and different parties (e.g., content providers, designer, editors, advertisers) who can contribute to the creation of publications.

The information could be obtained actively. Recipients, subscribers and contributors could be asked to fill out questionnaires, surveys, registration forms, etc. Information could be provided by parties knowledgeable about recipients and contributors. Publishers could provide optional tags, keywords or descriptions of their customized content. For customized content with online visibility, the amount and content of reader comments or reviews and coincident purchases could be used.

The information may be entered by recipients and contributors via a publisher interface. The publication service provider may include providing (e.g., uploading) the interface.

The information can also be obtained passively. Information could be obtained by searching data. Public databases and private databases (e.g., CRMS) could be searched.

Information could be inferred from behavior patterns (e.g., product purchases) and affiliations (e.g., college). Information could be inferred from analysis of any publisher content, such as inferring a publisher is a pet owner based on the relative incidence of pet images in the photographs. Information could be inferred from explicit publisher queries or keywords, recommendations or endorsements of other publishers, promotional codes offered through specific channels. Information could be inferred from analysis of any related metadata, such as inferring the publisher digital camera model from the image tags.

Information could be obtained before, while, or after a publication is customized. The information can be continually updated, refined, and expanded upon. Information about new recipients and contributors could be added to the information store.

The information may be restricted to parties who are members of a service. For example, the publishing service would identify only those contributors who have signed up with the service.

At block 420, the information is made available to allow a publisher to select certain parties to create a publication. The publisher interface may have access to a search engine for identifying the parties that can contribute to a specific publication. The search engine returns a list of contributors. The list may also include links that lead to greater detail about the contributors. The search engine may have the ability to rank the contributors.

In the alternative, the publishing service can inform the contributors about a publication and request them to submit bids. Interested contributors could submit bids directly to the publisher or they could submit bids to an intermediary such as the service provider.

The publishing service provider may provide other functions as well. At block 430, the flow of money between the various parties can be managed. The publishing service provider could facilitate the payment of royalties to content providers for their content. The publishing service provider could facilitate the payment of royalties to designers for usage of their designs and styling sheets. The publishing service provider could enable subscribers to get additional subsidization and printing points by referring others to the publishing service provider system or by closing purchases through the targeted ads in their publications. These are but a few examples.

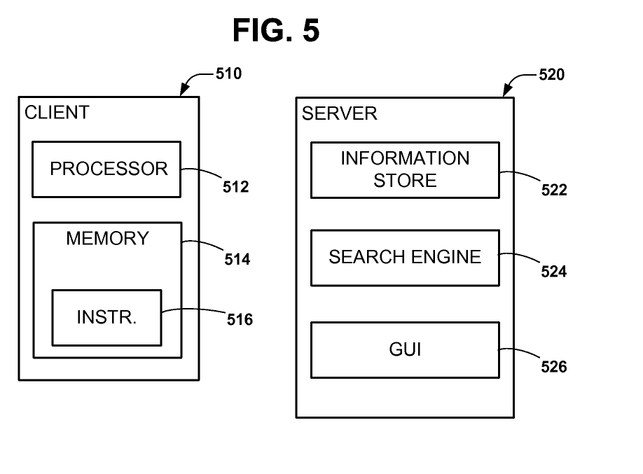

Reference is now made to FIG. 5, which illustrates an exemplary client 510 and server system 520 for the system of FIG. 2. The client 510 may be a machine that includes a processor 512 and memory 514 that stores instructions 516 for causing the processor 512 to run the publisher interface. The client 510 is not limited to any particular type of machine. Example of such machines include, without limitation, computers (e.g., desktop, laptop, PDAs and other handheld), mobile phones, printers, portable media players, gaming consoles, video cameras and digital cameras. The publisher interface can be implemented as a standalone application, a plug-in to a web browser, etc.

The publisher interface can be integrated with a search engine, image processing software (e.g., a photo editor), image display software (e.g., a photo album), file manager, or other suitable software. The publisher interface can be integrated with an operating system.

The server system 520 is not limited to any particular implementation. One or more servers may include an information store 522 and search engine 524. The server(s) may also store a graphical publisher interface 526, instances of which may be downloaded by clients 510. If the server system 520 includes multiple servers, the multiple servers may be in a central location or they may be distributed across different locations.

In some embodiments, the information store and search engines may be controlled by a single service provider. For instance, the information store and search engine(s) could be found on one or more servers.

In some embodiments, the information store and search engine could be controlled and maintained by different parties. For instance, one party stores the information on a first set of servers, and makes the information available to another party, which has the engines for searching the databases.

Although the publishing method and system above are described for print products, the present invention is not so limited. Products could be created and delivered in electronic form or some other form. The type of product and mode of delivery may be specified in the information about the recipient interests. In some embodiments, some of the customized instances of a publication may be created and delivered as electronic files.

In some embodiments, the publication could be a multimedia product (e.g., audio clips, video clips, radio, television). Instances containing customized content, design and advertising could be created and delivered as streaming media, electronic files, or in some other form. Other examples of other “publications” are software and blogs.

1. A publishing method comprising accessing information about interests of different recipients; generating customized instances of a publication for the different recipients, each instance customized according to its recipient's interests; and determining print product parameters for the instances according to the recipient interests.

2. The method of claim 1, wherein generating each customized instance includes including content that is customized according its recipient interests.

3. The method of claim 2, wherein the content includes proprietary material, and wherein including the content includes obtaining Intellectual Property rights in the proprietary material.

4. The method of claim 1, wherein generating each customized instance includes adding a design that is customized according to recipient interests.

5. The method of claim 1, wherein generating each customized instance includes including advertisements that are customized according to recipient interests.

6. The method of claim 1, further comprising generating print products from the customized instances, including distributing the customized instances or portions thereof among a plurality of print service providers.

7. The method of claim 6, wherein multiple print service providers are selected according to efficient resource allocation and geography.

8. The method of claim 6, wherein at least one print service provider is selected according to an accrued points system.

9. The method of claim 1 further comprising accessing information about different parties that can contribute to the creation of publications, and identifying those contributors by matching their information with recipient information.

10. The method of claim 9, wherein generating customized instances includes accessing at least one advertisement for each instance by matching advertiser interest with recipient interest.

11. The method of claim 9, wherein generating customized instances includes selecting at least one designer by matching recipient interest with designer information.

12. The method of claim 9, wherein generating customized instances includes selecting at least one editor by matching recipient interest with editor information.

13. The method of claim 9, further comprising using an interface to identify and select different parties that can contribute to the creation of the customized instances.

14. The method of claim 13, wherein the interface is used to directly identify the different parties.

15. The method of claim 14, wherein the interface is used to inform the different parties that a publication will be created in order to solicit contributor interest in creating the publication.

16. The method of claim 13, wherein the interface is used to accept bids from interested contributors.

17. The method of claim 11, wherein the interface is used to manage money flow.

18. The method of claim 1, wherein generating customized instances includes accessing a template of the publication and creating customized instances from the template.

19. The method of claim 18, wherein the publication is created over multiple iterations, and wherein each iteration includes sending a template from party to party, where each party adds content to the template and limits the amount of information that can be added by the next party.

20. Apparatus for creating a publication, comprising means for accessing information about interests of different recipients; means for generating customized instances of a publication for the different recipients, each instance customized according to its recipient's interests; and means for sending the customized instances to different print service providers for distributed printing.

21. A publishing method comprising:
collecting information about recipient interests;
collecting information about different parties that can contribute to the creation of publications; and
making the information available to allow a publisher to select certain parties to create instances of a publication that are customized according to the recipient interests.

22. The method of claim 21, wherein a publisher interface is used to allow the recipient and contributor information to be collected.

23. The method of claim 21, wherein the information is restricted to members.

24. The method of claim 21, wherein the interface includes providing access to a search engine for identifying the contributors who can create a specific publication.

25. The method of claim 24, wherein the search engine ranks the parties.

26. The method of claim 24, wherein the parties are identified from information that they provide.

27. The method of claim 24, wherein the parties are informed of a publication and requested to indicate whether they are interested.

28. The method of claim 21, wherein the interface is used to manage money flow.

29. The method of claim 28, wherein the interface is used to access content.

30. A publication creation service comprising:
means for collecting information about recipient interests;
means for collecting information about different parties that can contribute to the creation of publications; and
means for providing a publisher interface to allow publishers to select certain contributors to create publications.
